(19) United States
(12) Patent Application Publication
(10) Pub. No.: US 2015/0073705 A1
(43) Pub. Date: Mar. 12, 2015

(54) VEHICLE ENVIRONMENT RECOGNITION APPARATUS

(71) Applicant: FUJI JUKOGYO KABUSHIKI KAISHA, Tokyo (JP)

(72) Inventor: Yutaka HIWATASHI, Tokyo (JP)

(21) Appl. No.: 14/461,981

(22) Filed: Aug. 18, 2014

(30) Foreign Application Priority Data
Sep. 9, 2013 (JP) 2013-185942

(51) Int. Cl. G01C 21/36; G01S 19/13

(52) U.S. Cl. CPC G01C 21/3602; G01S 19/13
USPC 701/468

(57) ABSTRACT

A vehicle environment recognition apparatus includes: an image processing unit that acquires image data of captured detection area; a spatial position information generation unit that identifies relative positions of target portions in the detection area from the vehicle based on the image data; a specific object identification unit that identifies a specific object corresponding to the target portions based on the image data and the relative positions and stores the relative positions as image positions; a data position identification unit that identifies a data position, which is a relative position of the specific object from the vehicle, according to GPS-based absolute position of the vehicle and map data; a correction value derivation unit to derive a correction value which is a difference between the image position and the data position; and a position correction unit that corrects the GPS-based absolute position by the derived correction value.

### CROSS-REFERENCE TO RELATED APPLICATIONS

The present application claims priority from Japanese Patent Application No. 2013-185942 filed on Sep. 9, 2013, the entire contents of which are hereby incorporated by reference.

### BACKGROUND

1. Technical Field

The present disclosure relates to a vehicle environment recognition apparatus that recognizes the environment outside a vehicle, and particularly to a vehicle environment recognition apparatus that corrects GPS-based absolute position of the vehicle.

2. Related Art

In a conventional car navigation device, map data is used which allows three-dimensional objects, roads and others to be referenced as electronic data. In a known technology (for example, Japanese Unexamined Patent Application Publication (JP-A) No. H11-184375), in order to improve the accuracy of such map data, data of photographs captured from an airplane is converted to orthoimage data, road network data of the ground surface is extracted, and pieces of information are superimposed on the road network data. With this technology, geographical features can be represented on the map with high accuracy.

On the other hand, what is called adaptive cruise control (ACC) has attracted attention. ACC detects a stationary object such as a traffic signal or a traffic lane, estimates a travel route (travel path) along which the vehicle travels, and thus supports the operation of a driver. ACC also detects a moving object such as another vehicle (preceding vehicle) present ahead of the vehicle, and maintains a safe distance between the vehicle and the moving object while avoiding a collision with the preceding vehicle.

With the above-mentioned technology, the outside environment ahead of the vehicle is recognized based on image data obtained from an image capture device mounted in the vehicle, and the vehicle is controlled according to the travel route along which the vehicle should travel or movement of a preceding vehicle. However, recognizable environment outside the vehicle is limited to a detection area which can be captured by the image capture device, and so a blind spot and an area away from the vehicle, which are not easily captured, are difficult to be recognized.

Thus, the inventor has reached the idea of improving the accuracy of traveling control by using map data to recognize the environment outside the vehicle in a wide range which is difficult to be captured and by utilizing even a travel route at a distant location as control input. In this manner, it is possible to control the vehicle more comfortably, for example, to stop or decelerate the vehicle by recognizing road conditions at a distant location.

However, map data used in a car navigation device or the like has only fixed geographical features, and thus it may not be possible to recognize the relative positional relationship between stationary objects shown on the map and the travelling vehicle. Although it is possible to estimate the absolute position of the vehicle using a global positioning system (GPS) mounted in the vehicle, the positional accuracy of GPS is not so high, and thus when an error in the absolute position is introduced into the control input, the operation of a driver may not be sufficiently supported.

### SUMMARY OF THE INVENTION

In view of such a problem, the present disclosure provides a vehicle environment recognition apparatus that enables comfortable driving by correcting the GPS-based absolute position of the vehicle with high accuracy.

In order to solve the above-mentioned problem, an aspect of the present disclosure provides a vehicle environment recognition apparatus including: an image processing unit that acquires image data of captured detection area; a spatial position information generation unit that identifies relative positions of a plurality of target portions in the detection area with respect to the vehicle based on the image data; a specific object identification unit that identifies a specific object corresponding to the target portions based on the image data and the relative positions of the target portions and stores the relative positions of the target portions as image positions; a data position identification unit that identifies a data position according to a GPS-based absolute position of the vehicle and map data, the data position being a relative position of the specific object with respect to the vehicle; a correction value derivation unit that derives a correction value which is a difference between the image position and the data position; and a position correction unit that corrects the GPS-based absolute position of the vehicle by the derived correction value.

The correction value derivation unit may derive a correction value intermittently during a time period in which the specific object identification unit can identify a specific object.

The vehicle environment recognition apparatus may further include a vehicle environment detection unit that detects an environment outside the vehicle; and a reference determination unit that determines according to the environment outside the vehicle which either one of the relative position based on the image data and the corrected GPS-based absolute position is to be used for predetermined control.

The specific object may be a point which is on a travel route along which the vehicle travels and away from the vehicle by a predetermined distance.

The specific object may be a traffic signal or a road sign.

### BRIEF DESCRIPTION OF THE DRAWINGS

FIG. 1 is a block diagram illustrating a connection relationship of an environment recognition system;

FIG. 2 is a functional block diagram illustrating schematic functions of a vehicle environment recognition apparatus;

FIGS. 3A and 3B are explanatory diagrams for explaining a luminance image and a distance image;

FIG. 4 is an explanatory diagram for explaining a specific operation of a traffic signal;

FIG. 5 is a control block diagram illustrating a flow of driving support control;

FIG. 6 is an explanatory diagram for explaining a travel route;

FIG. 7 is a functional block diagram illustrating schematic functions of the vehicle environment recognition apparatus; and

FIG. 8 is a flow chart for explaining schematic flow of interruption processing of a vehicle environment detection unit and a reference determination unit.

### DETAILED DESCRIPTION

Hereinafter, a preferred implementation of the present disclosure will be described in detail with reference to the accompanying drawings. The dimensions, material, and other specific numeric values presented in the implementations are only for the illustration to facilitate understanding of the disclosure and are not intended to limit the present disclosure unless otherwise specified. In the present description and drawings, the elements having essentially the same function, configuration are denoted by the same symbols and redundant description is thereby omitted. Also, any element which is unrelated to the present disclosure will not be illustrated.

In recent years, driving support technology has spread. With the technology, the outside environment ahead of a vehicle is captured by an image capture device mounted in the vehicle, a specific object such as a traffic signal or a traffic lane is detected based on color information and position information in the captured image, and a travel route of the vehicle is estimated, thereby supporting the driving operation of a driver. However, recognizable environment outside a vehicle is limited to a detection area which can be captured by the image capture device, and so a blind spot and an area away from the vehicle are difficult to be recognized.

Thus, in the present implementations, map data is used which allows three-dimensional objects, roads and others to be referenced as electronic data, the vehicle environment in an area which is difficult to be captured is recognized, and whereby a long travel route to a distant location is utilized as control input, and the accuracy of traveling control is improved. However, the relative positional relationship between a specific object shown on the map and the travelling vehicle may not be recognized using the map data only. Although it is possible to recognize the absolute position of the vehicle using GPS mounted in the vehicle, the positional accuracy of GPS is not so high, and thus even when the absolute position of the vehicle including an error is introduced into the control input, the operation of a driver may not be sufficiently supported. Thus, in the present implementations, a relative position derived based on an image is used to correct the GPS-based absolute position of the vehicle with high accuracy, and information of the map data, which is difficult to be obtained with an image capture device, is utilized, thereby achieving comfortable driving.

### (Environment Recognition System 100)

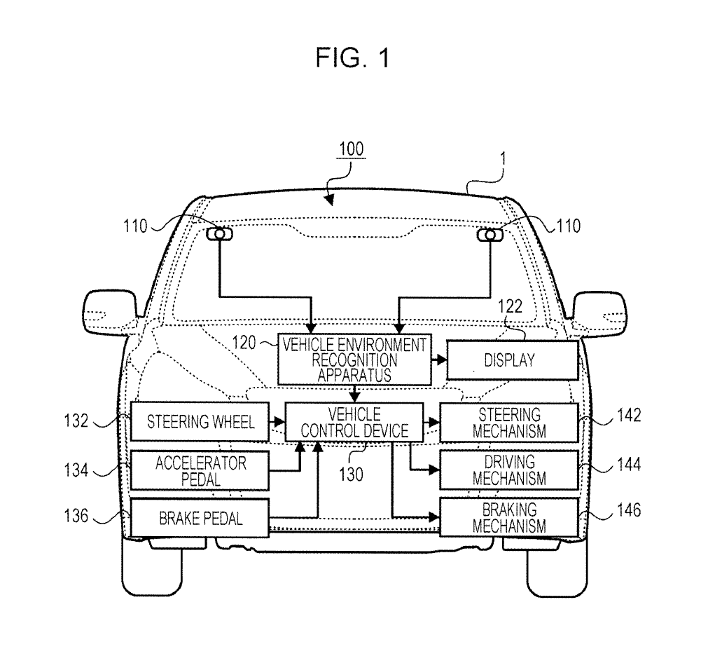

FIG. 1 is a block diagram illustrating a connection relationship of an environment recognition system 100. The environment recognition system 100 includes an image capture device 110 provided in a vehicle 1, a vehicle environment recognition apparatus 120, and a vehicle control device (engine control unit (ECU) 130.

The image capture device 110 includes an imaging device such as a charge-coupled device (CCD) or a complementary metal-oxide semiconductor (CMOS), and is capable of capturing the environment ahead of the vehicle 1 and generating a color image including three hues (red (R), green (G), blue (B)) or a monochrome image. Here, a color image captured by the image capture device 110 is called an luminance image and is distinguished from a distance image described later.

Two image capture devices 110 are disposed to be spaced apart from each other substantially in a horizontal direction so that the optical axes of the image capture devices 110 are substantially parallel in the area ahead of the vehicle 1 in a travelling direction. Each image capture device 110 continuously generates frames of captured image data of an object present ahead of the vehicle 1 for every 1/60 second (60 fps), for example. Here, target objects to be recognized as specific objects include not only independent three-dimensional objects such as a vehicle, a pedestrian, a traffic signal, a road sign, a traffic lane, a road, and a guardrail, but also an object which can be identified as part of a three-dimensional object, such as a tail light, a blinker, lights of a traffic signal and also a travel route which is derived by further operations based on these objects. Each of the functional units in the following implementation executes relevant processing for every frame upon updating such image data.

The vehicle environment recognition apparatus 120 acquires image data from each of the two image capture devices 110, derives a parallax using so-called pattern matching, and generates a distance image by associating the derived parallax information (which corresponds to the depth distance that is a distance in the forward direction of the vehicle) with the image data. The luminance image and the distance image will be described in detail later. In addition, the vehicle environment recognition apparatus 120 identifies that an object in the detection area ahead of the vehicle corresponds to which one of the specific objects, using a luminance based on the luminance image and a depth distance from the vehicle 1 based on the distance image.

Upon identifying a specific object, the vehicle environment recognition apparatus 120 derives a travel route according to the specific object (for example, a traffic lane), and outputs relevant information to the vehicle environment recognition apparatus 120 so that a driver can properly drive the vehicle along the derived travel route, thereby supporting the operation of a driver. Furthermore, the vehicle environment recognition apparatus 120 derives the relative velocity of any specific object (for example, a preceding vehicle) while keeping track of the specific object, and determines whether or not the probability of collision between the specific object and the vehicle 1 is high. When the probability of collision is determined to be high, the vehicle environment recognition apparatus 120 displays a warning (notification) for a driver on a display 122 installed in front of the driver, and outputs information indicating the warning to the vehicle control device 130.

The vehicle control device 130 receives an operation input of a driver via a steering wheel 132, an accelerator pedal 134, and a brake pedal 136, and controls the vehicle 1 by transmitting the operation input to a steering mechanism 142, a driving mechanism 144, and a braking mechanism 146. The vehicle control device 130 controls the steering mechanism 142, the driving mechanism 144, and the braking mechanism 146 in accordance with a command from the vehicle environment recognition apparatus 120.

Hereinafter, the configuration of the vehicle environment recognition apparatus 120 will be described in detail. Here, correction of the GPS-based absolute position of the vehicle 1, that is, the distinctive feature of the present implementation will be described in detail, and description of any configuration unrelated to the feature of the present disclosure is omitted.

### (First Implementation: Vehicle Environment Recognition Device 120)

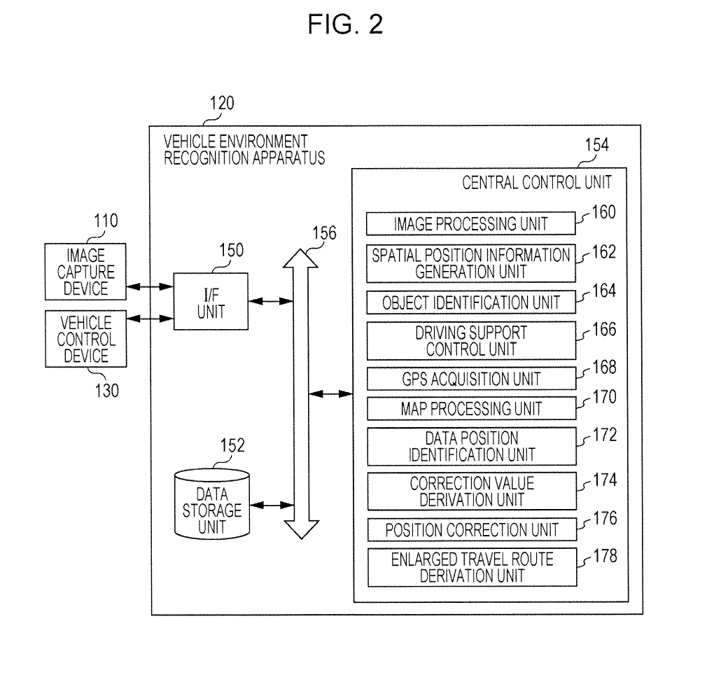

FIG. 2 is a functional block diagram illustrating schematic functions of the vehicle environment recognition apparatus 120. As illustrated in FIG. 2, the vehicle environment recognition apparatus 120 includes an I/F unit 150, a data storage unit 152, and a central control unit 154.

The I/F unit 150 is an interface for exchanging information with the image capture devices 110 and the vehicle control device 130 bidirectionally. The data storage unit 152 includes a RAM, a flash memory, and a HDD, stores various information necessary for the processing of the functional units mentioned below, and temporarily stores image data received from the image capture devices 110.

The central control unit 154 is comprised of a semiconductor integrated circuit including a central processing unit (CPU), a ROM storing programs and others, and a RAM as a work area, and controls the I/F unit 150 and the data storage unit 152 through a system bus 156. In the present implementation, the central control unit 154 also functions as an image processing unit 160, a spatial position information generation unit 162, a specific object identification unit 164, a driving support control unit 166, a GPS acquisition unit 168, a map processing unit 170, a data position identification unit 172, a correction value derivation unit 174, a position correction unit 176, and an enlarged travel route derivation unit 178. Hereinafter, based on general purposes of these functional units, detailed operations of image processing, specific object identification processing, driving support control, and correction of PS-based absolute position of the vehicle 1 will be described in this order.

### (Image Processing)

The image processing unit 160 acquires image data from each of the two image capture devices 110, and derives a parallax using so-called pattern matching in which any block (for example, arrangement of horizontal 4 pixels×vertical 4 pixels) is extracted from one piece of image data and a corresponding block is retrieved from the other piece of image data. Herein, “horizontal” indicates a horizontal direction of a captured luminance image on the screen and “vertical” indicates a vertical direction of the captured luminance image on the screen.

For the pattern matching, the luminance (Y color difference signal) may be compared between two pieces of image data for each block unit indicating any position in the image. For example, comparison techniques include Sum of Absolute Difference (SAD) which uses a difference in luminance, Sum of Squared luminance Difference (SSD) which uses square of difference, and Normalized Cross Correlation (NCC) which uses the degree of similarity of a variance value which is obtained by subtracting the average value from the luminance of each pixel. The image processing unit 160 performs such block-by-block parallax derivation processing on all blocks displayed on a detection area (for example, horizontal 600 pixels×vertical 180 pixels). Although each block has horizontal 4 pixels×vertical 4 pixels herein, the number of pixels in each block may be set to any number.

Note that although the image processing unit 160 can derive a parallax for each block that is a detection resolution unit, the image processing unit 160 is not able to recognize what type of object includes the block as part. Therefore, parallax information is derived independently for a detection resolution unit (for example, a block unit) in a detection area rather than an object unit. Herein, a distance image refers to an image in which a parallax information (which corresponds to a depth distance) derived in this manner is associated with the image data.

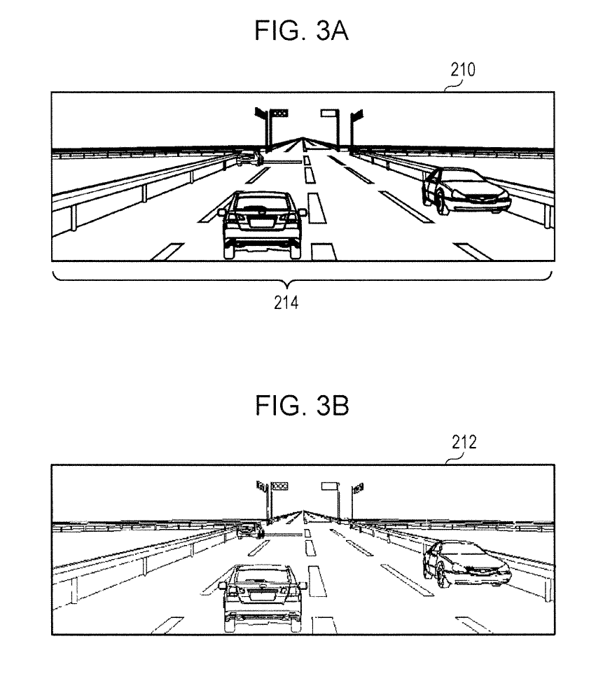

FIGS. 3A and 3B are explanatory diagrams for explaining a luminance image 210 and a distance image 212. For example, assume that the luminance image (image data) 210 for a detection area 214 has been generated as illustrated in FIG. 3A via two image capture devices 110. It should be noted that for the purpose of facilitating understanding, only one of two luminance images 210 is schematically illustrated. In the present implementation, the image processing unit 160 determines a parallax for each block based on such luminance image 210 and forms the distance image 212 as illustrated in FIG. 3B. Each block in the distance image 212 is associated with the parallax of the block. Here, for the convenience of description, a block for which a parallax has been derived is denoted by a black dot.

Returning to FIG. 2, based on the distance image 212 generated by the image processing unit 160, the spatial position information generation unit 162 converts parallax information for each block in the detection area 214 to three-dimensional position information (relative position) including a horizontal distance, a height (perpendicular distance), and a depth distance, by using what is called a stereo method. However, in the present implementation, it is sufficient that two-dimensional relative positions including at least a horizontal distance and a depth distance are identified. Here, the stereo method is a method of deriving the depth distance of an object with respect to the image capture device 110 based on a parallax of the object, using triangulation method. In the above process, the spatial position information generation unit 162 derives the height of a target portions from the road surface based on the depth distance of the target portion and a detection distance on the distance image 212, the detection distance being between the target portion and a point on the road surface which has the same depth distance as the target portion. Because various known technologies are applicable to derivation processing for the above-mentioned depth distance and identification processing for a three-dimensional position, the description thereof is omitted herein.

### (Specific Object Identification Processing)

The specific object identification unit 164 determines that a target portion (pixels and/or block) in the detection area 214 corresponds to which one of the specific objects, using a luminance based on the luminance image 210 and three-dimensional relative positions based on the distance image 212. The specific object identification unit 164 then stores the relative position of the determined specific object into the data storage unit 152 as an image position which is associated with the specific object. For example, in the present implementation, the specific object identification unit 164 identifies a single or a plurality of traffic signals located ahead of the vehicle 1, and signal color (red signal color, yellow signal color, blue signal color) light of each of traffic signals.

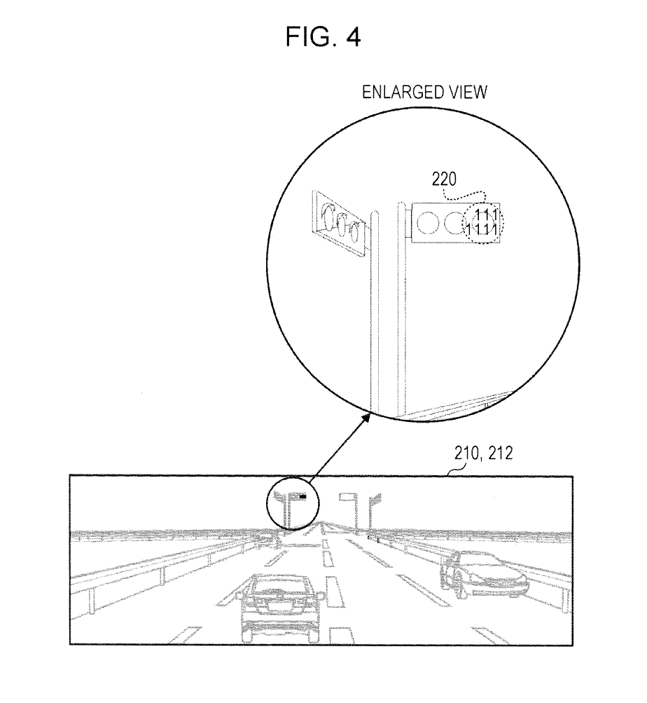

FIG. 4 is an explanatory diagram for explaining a specific operation of a traffic signal. Hereinafter, identification step will be described by giving an example of identification processing for the red signal color of a traffic signal. First, the specific object identification unit 164 determines whether or not the luminance of any target portion in the luminance image 210 is included in a luminance range (for example, with a reference value of luminance (R), luminance (G) is 0.5 times the reference value (R) or less, and luminance (B) is 0.38 times the reference value (R) or less) of a specific object (red signal color). In the case where the luminance of the target portion is included in a target luminance range, an identification number indicating the specific object is labeled with the target portion. Here, as illustrated by the enlarged view of FIG. 4, an identification number “1” is labeled with the target portion corresponding to the specific object (red signal color).

Next, with any target portion as a reference point, the specific object identification unit 164 classifies a target portion into the same group in the case where a difference in horizontal distance and a difference in height (a difference in depth distance may be further included) between the target portion and the reference point is within a predetermined range, and the target portion probably corresponds to the same specific object (the same identification number is labeled). Here, a predetermined range is expressed by a distance in the real space, and can be set to any value (for example, 1.0 m). In addition, with another target portion newly added by the classification as a reference point, the specific object identification unit 164 classifies a target portion into the same group in the case where a difference in horizontal distance and a difference in height between the target portion and the reference point is within a predetermined range and the target portion corresponds to the same specific object (red signal color). As a consequence, when the distance between target portions with the same identification number labeled is within a predetermined range, all the target portions are classified into the same group. Here, as illustrated by the enlarged view of FIG. 4, the target portions with the identification number “1” labeled form a target portion group 220.

Next, the specific object identification unit 164 determines whether or not the classified target portion group 220 satisfies predetermined conditions associated with the specific object, such as a height range (for example, 4.5 to 7.0 m), a width range (for example, 0.05 to 0.2 m), and a shape (for example, a circular shape). Here, comparison (pattern matching) of the shape is made by referring to templates which are previously associated with a specific object and presence of a correlation of a predetermined value or higher determines that the predetermined conditions are satisfied. When the predetermined conditions are satisfied, the classified target portion group 220 is determined to be a specific object (red signal color) or a specific object (traffic signal). In this manner, the specific object identification unit 164 can identify a traffic signal based on the image data. Although an example has been given where a traffic signal is identified by the red signal color, it goes without saying that a traffic signal can be identified based on the yellow signal color or the blue signal color.

When the target portion group 220 has features peculiar to a specific object, the features may be used as the conditions for determining the specific object. For example, when emitting elements of a traffic signal are light emitting diodes (LED), the emitting elements blink with a period (for example, 100 Hz) which is not recognizable by human eyes. Therefore, the specific object identification unit 164 can also determine a specific object (red signal color) based on blinking timing of the LEDs and asynchronously-acquired temporal variation in the luminance of a target portion in the luminance image 210.

Also, the specific object identification unit 164 can identify a travel route along which the vehicle 1 travels by processing similar to the processing for a traffic signal. In this case, the specific object identification unit 164 first identifies a plurality of white lines on the road appearing ahead of the vehicle. Specifically, the specific object identification unit 164 determines whether or not the luminance of any target portion falls within the luminance range of the specific object (white lines). When target portions are within a predetermined range, the specific object identification unit 164 classifies those target portions into the same group, and the target portions form an integral target portion group.

Subsequently, the specific object identification unit 164 determines whether or not the classified target portion group satisfies predetermined conditions associated with the specific object (white lines), such as a height range (for example, on the road surface), a width range (for example, 0.10 to 0.25 m), and a shape (for example, a solid line or a dashed line). When the predetermined conditions are satisfied, the classified target portion group is determined to be the specific object (white lines). Subsequently, the specific object identification unit 164 extracts right and left side white lines one for each side out of the identified white lines on the road appearing ahead of the vehicle, the white lines being closest to the vehicle 1 in horizontal distance. The specific object identification unit 164 then derives a travel route that is a line located in the middle of and parallel to the extracted right and left side white lines. In this manner, the specific object identification unit 164 can identify a travel route based on the image data.

### (Driving Support Control)

The driving support control unit 166 supports the operation of a driver based on the travel route identified by the specific object identification unit 164. For example, the driving support control unit 166 estimates a travel route along which the vehicle 1 actually travels, according to the running state (for example, a yaw rate, speed) of the vehicle 1, and controls the running state of the vehicle 1 so as to match the actual travel route with the travel route identified by the specific object identification unit 164, that is, so as to keep the vehicle 1 running appropriately along a traffic lane. For derivation of the actual travel route, various existing technologies are applicable, and thus a description thereof is omitted herein, the existing technologies being disclosed, for example, in JP-A Nos. 2012-185562, 2010-100120, 2008-130059, and 2007-186175.

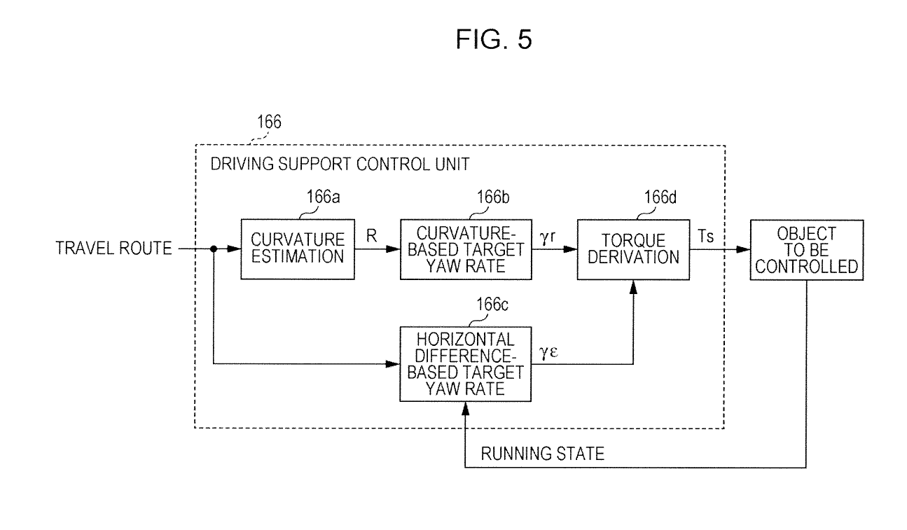

FIG. 5 is a control block diagram illustrating a flow of driving support control. The driving support control unit 166 includes a curvature estimation module 166a, a curvature-based target yaw rate module 166b, a horizontal difference-based target yaw rate module 166c, and a torque derivation module 166d, and supports the operation of a driver according to a travel route.

First, the curvature estimation module 166a derives a curvature radius R of a curve indicated by the travel route based on the travel route derived based on image data. The curvature-based target yaw rate module 166b derives a target yaw rate γr which should occur in the vehicle 1 based on the curvature derived by the curvature estimation module 166a.

The horizontal difference-based target yaw rate module 166c derives the horizontal distance of the intersection point (front fixation point) between the travel route derived based on the image data and the front fixation line ahead of the vehicle, and also derives the horizontal distance of the intersection point with the front fixation line in the case where the vehicle passes through the front fixation line with the current running state (the speed, yaw rate, steering angle of the vehicle 1) maintained. The horizontal difference-based target yaw rate module 166c derives a yaw rate necessary to cause the difference (horizontal difference) ε in horizontal distance between the intersection points to be 0 (zero), and the derived yaw rate is referred to as a horizontal difference-based target yaw rate γε. Here, the front fixation line is a perpendicular line (line extending in the width direction) through a point ahead of the vehicle 1 by a predetermined distance (for example, 10.24 m) and perpendicular to the line (forward straight line) extending in the forward direction from the center of the width of the vehicle. The horizontal distance herein indicates a distance from the forward straight line on the front fixation line.

The torque derivation module 166d derives a comprehensive target yaw rate γs by multiplying a target yaw rate γr and a target yaw rate γε by respective predetermined tuning coefficients kr, kε (for example, kr=0.5, kε=0.5) and adding up together as in the following Expression 1, the target yaw rate γr being based on the curvature as a feed forward term, the target yaw rate γε being based on the horizontal difference as a feed back term.

γs=kr·γr+kε·γε (Expression 1)

The torque derivation module 166d then derives a target steering angle θs for achieving the comprehensive target yaw rate γs like the above, and outputs a target steering torque Ts determined by the target steering angle θs to an object to be controlled, for example, the driving mechanism 144. Specific processing for the above-mentioned driving support control is described in Japanese Unexamined Patent Application Publication No. 2004-199286 filed by the present assignee, and thus detailed description is omitted. In this manner, the driving support control unit 166 is capable of supporting the operation of a driver based on the travel route.

### (Correction of GPS-based Absolute Position of Vehicle 1)

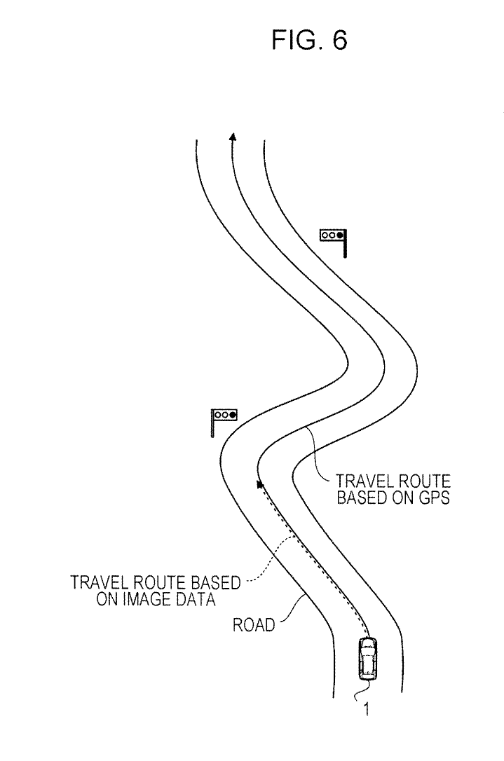

FIG. 6 is an explanatory diagram for explaining a travel route. In the driving support control described above, the specific object identification unit 164 supports driving operation using the travel route which is identified based on the image data. However, when driving support is controlled using the travel route based on the image data, a sufficiently long travel route to a distant location may not be obtained as indicated by a dashed line arrow in FIG. 6. In the present implementation, as described above, map data is used and a travel route (“travel route based on GPS” indicated by a solid line arrow in FIG. 6) is introduced, the route also including an area which is difficult to be captured, thereby improving the accuracy of traveling control. Although the absolute position of the vehicle 1 on the map data needs to be derived by GPS mounted in the vehicle 1 when the map data is utilized, the positional accuracy of the GPS-based absolute position of the vehicle 1 is not so high. Thus, the GPS-based absolute position of the vehicle 1 is corrected as follows.

The GPS acquisition unit 168 acquires the absolute position (for example, latitude, longitude) of the vehicle 1 via GPS. The map processing unit 170 refers to the map data, and acquires road information in the vicinity where the vehicle 1 is running. Although the map data may be stored in the data storage unit 152, the map data may be acquired from a navigation device mounted in the vehicle 1 or a communication network such as the Internet.

The data position identification unit 172 refers to the absolute position of the vehicle 1 acquired by the GPS acquisition unit 168, and derives the location of the vehicle 1 on the map data. The data position identification unit 172 then derives a data position based on the absolute position of the vehicle 1 on the map data as well as the absolute position of a target specific object, the data position being a relative position of the specific object with respect to the vehicle 1.

Here, specific objects applicable as targets include a specific object for which the absolute position is indicated on the map data and a specific object for which the absolute position can be determined by operations based on the absolute positions of other specific objects on the map data. The former applicable specific object includes, for example, a traffic signal and a road sign, and the latter applicable specific object includes a point that is on a travel route and away from the vehicle 1 by a predetermined distance, for example, an intersection point between the travel route and the front fixation line ahead of the vehicle. Here, the road sign includes a guide sign, a warning sign, a regulatory sign, an indication sign, and an auxiliary sign.

When an intersection point between a travel route and a front fixation line ahead is used as a target specific point, independently of the later-described enlarged travel route derivation unit 178, the data position identification unit 172 derives a travel route on the map data and derives the intersection point between the travel route and the front fixation line ahead based on the road information on the map data and the absolute position of the vehicle 1 acquired by the GPS acquisition unit 168.

The correction value derivation unit 174 compares the image position derived by the specific object identification unit 164 with the data position derived by the data position identification unit 172, derives a correction value which is the difference (the image position—the data position), and stores the correction value in the data storage unit 152. Here, a correction value may be indicated by a latitude difference and a longitude difference. When a plurality of target specific objects are selected rather than a single target specific object, for example, a traffic signal and an intersection point between a travel route and the front fixation line ahead the vehicle are selected, the difference between the image position and the data position for each target may be averaged and used as a correction value.

However, the specific object identification unit 164 is not always capable of identifying a specific object, and in the case where effective image data is not available from the image capture device 110 due to some cause such as the weather (environment outside the vehicle), a specific object may not be accurately identified. In this case, the correction value derivation unit 174 derives a correction value in a time period in which a specific object can be identified by the specific object identification unit 164. Also, in order to reduce processing load, the correction value derivation unit 174 derives a correction value intermittently (as one example, once in 5 minutes) in a time period in which a specific object can be identified. When a correction value is newly derived in this manner, the correction value currently stored in the data storage unit 152 is updated.

The position correction unit 176 corrects GPS-based absolute position of the vehicle 1 by adding the derived correction value to the absolute position of the vehicle 1 which is acquired by the GPS acquisition unit 168.

The enlarged travel route derivation unit 178 derives a travel route on the map data using the road information on the map data and the corrected GPS-based absolute position of the vehicle 1. The driving support control unit 166 supports the operation of a driver based on the travel route derived by the enlarged travel route derivation unit 178 instead of the travel route identified by the specific object identification unit 164. In this manner, the GPS-based absolute position of the vehicle is corrected with high accuracy, and information of the map data, which is difficult to be recognized with the image capture device 110, is utilized, thereby providing a sufficiently long travel route and thus achieving comfortable driving.

### (Second Implementation)

In the first implementation, the relative position of a specific object based on the image data and the relative position of the specific object based on GPS are compared with each other, the GPS-based absolute position of the vehicle 1 is corrected by the difference (correction value), a travel route is further calculated with the map data which reflects the corrected GPS-based absolute position of the vehicle 1, and the travel route based on GPS is utilized instead of a travel route based on the image data.

However, GPS-based absolute position of the vehicle 1 is not always able to be acquired, and as described above, image data is not always able to be acquired either. Thus, in the present implementation, on the assumption that both the GPS-based absolute positions and the image data-based relative positions are available, position information used for predetermined control such as above-described driving support control is switched between the GPS-based absolute position and the image data-based relative position according to the environment outside the vehicle.

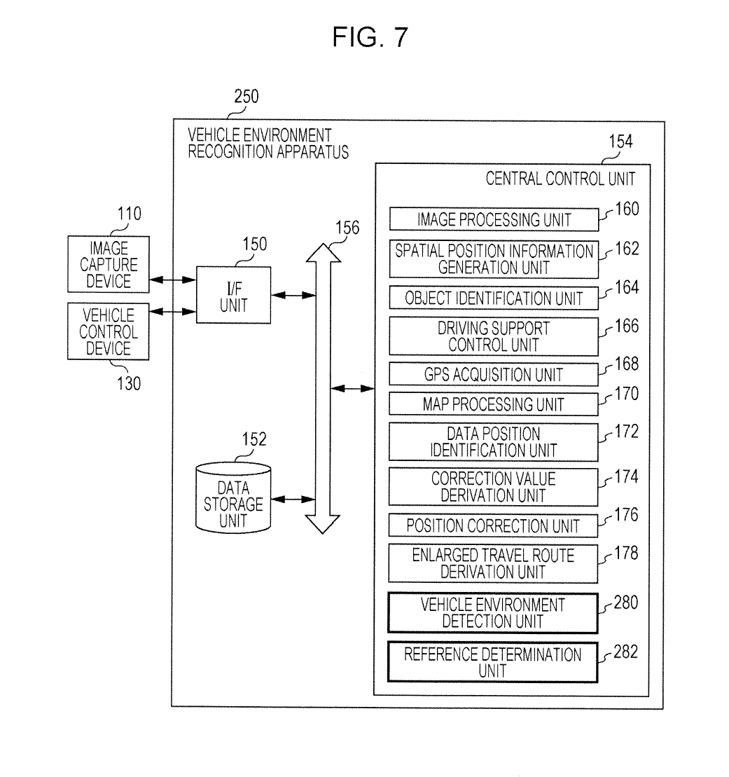

FIG. 7 is a functional block diagram illustrating schematic functions of a vehicle environment recognition apparatus 250. As illustrated in FIG. 7, the vehicle environment recognition apparatus 250 includes the I/F unit 150, the data storage unit 152, and the central control unit 154. The central control unit 154 also functions as an image processing unit 160, a spatial position information generation unit 162, a specific object identification unit 164, a driving support control unit 166, a GPS acquisition unit 168, a map processing unit 170, a data position identification unit 172, a correction value derivation unit 174, a position correction unit 176, an enlarged travel route derivation unit 178, a vehicle environment detection unit 280, and a reference determination unit 282. The following components in the first implementation described above have essentially the same functions as in the second implementation and thus redundant description is omitted: the I/F unit 150, the data storage unit 152, the central control unit 154, the image processing unit 160, the spatial position information generation unit 162, the specific object identification unit 164, the driving support control unit 166, the GPS acquisition unit 168, the map processing unit 170, the data position identification unit 172, the correction value derivation unit 174, the position correction unit 176, and the enlarged travel route derivation unit 178. Hereinafter, the vehicle environment detection unit 280 and the reference determination unit 282 reflecting a different configuration will be mainly described.

The vehicle environmental detection unit 280 detects the environment outside a vehicle, particularly the image-capturing environment of the image capture device 110 and the radio wave environment of GPS.

The reference determination unit 282 determines which either one of the image data-based relative position and the corrected GPS-based absolute position is used for predetermined control, according to the environment outside the vehicle detected by the environment detection unit 280.

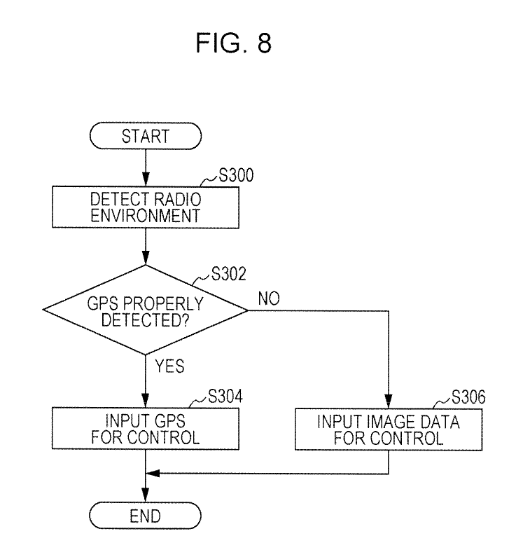

FIG. 8 is a flow chart for explaining schematic flow of interruption processing of the vehicle environment detection unit 280 and the reference determination unit 282. The vehicle environment detection unit 280 detects the radio wave environment of GPS (S300), and determines whether or not the GPS-based absolute position of the vehicle 1 is effectively detected (S302), for example, the space outside the vehicle is open (not inside a tunnel). When the GPS-based absolute position of the vehicle 1 is effectively detected (YES in S302), the reference determination unit 282 determines that the GPS-based absolute position is used for the control (S304). Otherwise, when the GPS-based absolute position of the vehicle 1 is not effectively detected (NO in S302), the reference determination unit 282 determines that the image data-based relative position is used for the control (S306).

In this manner, in an area which is not inside a tunnel or between high buildings, traveling control with reference of GPS-based absolute position is performed, and even when effective image data is not available from the image capture device 110 due to some cause such as cloudy weather or rain, traveling control for the vehicle 1 can be maintained with high accuracy. In an area such as inside a tunnel or between high buildings where GPS-based absolute position of the vehicle 1 is not effectively detected, traveling control is performed with reference of relative position based on image data instead of GPS, and again traveling control for the vehicle 1 can be maintained with high accuracy.

### (Third Implementation)

The second implementation has been described by giving an example in which either one of the GPS-based absolute position and the image data-based relative position is selected according to the environment outside the vehicle and is used for control. However, when the GPS-based absolute position and the image data-based relative position are both effective, both positions can also be used complementarily. For example, while traveling control is being performed based on either one, the reliability of the control is evaluated based on the other. In this manner, the reliability and accuracy of both positions can be mutually increased and more stable traveling control is made possible.

As described above so far, with the aforementioned vehicle environment recognition apparatuses 120, 250, the GPS-based absolute position of the vehicle 1 can be corrected with high accuracy. In addition, comfortable driving can be achieved by performing traveling control using map data based on the GPS corrected in this manner. Furthermore, by using either one of the GPS-based absolute position and the image data-based relative position for traveling control according to the environment outside the vehicle, stable and highly accurate traveling control can be maintained irrespective of change in the environment outside the vehicle.

There are also provided a program which causes a computer to function as the vehicle environment recognition apparatus 120, and a storage medium on which the program is recorded, such as a computer-readable flexible disk, magnetic-optical disk, ROM, CD, DVD, BD. Here, a program refers to a data processing method which is written in any language or by a descriptive method.

So far, although a preferred implementation of the present disclosure has been described with reference to the accompanying drawings, it goes without saying that the present disclosure is not limited to the above implementations. It is apparent that various modifications and alterations may occur to those skilled in the art within a range described in the appended claims and it is understood that these modifications and alterations naturally fall within the technical scope of the present disclosure.

For example, although driving support control has been given and described as predetermined control for which GPS and map data are used in the above implementations, without being limited to the above case, the present disclosure is applicable to various types of control such as preceding vehicle following control, steering angle control, torque control, deceleration control, and stop control in ACC.

Although the above implementations have been described by giving an example in which the two image capture devices 110, which are disposed to be spaced apart from each other, are used, the present implementations can be implemented with only one image capture device as long as the specific objects can be identified.

The present disclosure relates to a vehicle environment recognition apparatus that recognizes the environment outside the vehicle, and is particularly applicable to a vehicle environment recognition apparatus that corrects GPS-based absolute position of the vehicle.

1. A vehicle environment recognition apparatus comprising:
an image processing unit that acquires image data of a captured detection area;
a spatial position information generation unit that identifies relative positions of a plurality of target portions in the detection area with respect to the vehicle based on the image data;
a specific object identification unit that identifies a specific object corresponding to the target portions based on the image data and the relative positions of the target portions and stores the relative positions of the target portions as image positions;
a data position identification unit that identifies a data position according to a GPS-based absolute position of the vehicle and map data, the data position being a relative position of the specific object with respect to the vehicle;
a correction value derivation unit that derives a correction value which is a difference between the image position and the data position; and
a position correction unit that corrects the GPS-based absolute position of the vehicle by the derived correction value.

2. The vehicle environment recognition apparatus according to claim 1,
wherein the correction value derivation unit derives a correction value intermittently during a time period in which the specific object identification unit can identify the specific object.

3. The vehicle environment recognition apparatus according to claim 1, further comprising:
a vehicle environment detection unit that detects an environment outside the vehicle; and
a reference determination unit that determines according to the environment outside the vehicle which one of the relative position based on the image data and the corrected GPS-based absolute position is to be used for predetermined control.

4. The vehicle environment recognition apparatus according to claim 2, further comprising:
a vehicle environment detection unit that detects an environment outside the vehicle; and
a reference determination unit that determines according to the environment outside the vehicle which one of the relative position based on the image data and the corrected GPS-based absolute position is to be used for predetermined control.

5. The vehicle environment recognition apparatus according to claim 1,
wherein the specific object is a point which is on a travel route along which the vehicle travels and away from the vehicle by a predetermined distance.

6. The vehicle environment recognition apparatus according to claim 2,
wherein the specific object is a point which is on a travel route along which the vehicle travels and away from the vehicle by a predetermined distance.

7. The vehicle environment recognition apparatus according to claim 3,
wherein the specific object is a point which is on a travel route along which the vehicle travels and away from the vehicle by a predetermined distance.

8. The vehicle environment recognition apparatus according to claim 4,
wherein the specific object is a point which is on a travel route along which the vehicle travels and away from the vehicle by a predetermined distance.

9. The vehicle environment recognition apparatus according to claim 1,
wherein the specific object is a traffic signal or a road sign.

10. The vehicle environment recognition apparatus according to claim 2,
wherein the specific object is a traffic signal or a road sign.

11. The vehicle environment recognition apparatus according to claim 3,
wherein the specific object is a traffic signal or a road sign.

12. The vehicle environment recognition apparatus according to claim 4,
wherein the specific object is a traffic signal or a road sign.

13. The vehicle environment recognition apparatus according to claim 5,
wherein the specific object is a traffic signal or a road sign.

14. The vehicle environment recognition apparatus according to claim 6,
wherein the specific object is a traffic signal or a road sign.

15. The vehicle environment recognition apparatus according to claim 7,
wherein the specific object is a traffic signal or a road sign.

16. The vehicle environment recognition apparatus according to claim 8,
wherein the specific object is a traffic signal or a road sign.
